(19) United States
(12) Patent Application Publication
(10) Pub. No.: US 2008/0152889 A1
(43) Pub. Date: Jun. 26, 2008

(54) Nano-Labeling

(76) Inventor: Hans-Achim Brand, Duren (DE)

Correspondence Address: COLLARD & ROE, P.C., 1077 NORTHERN BOULEVARD, ROSLYN, NY, 11576, US

(21) Appl. No.: 11/921,979

(22) PCT Filed: May 10, 2006
(86) PCT No.: PCT/DE2006/000840

§ 371 Date: Jan. 24, 2008

(30) Foreign Application Priority Data
May 10, 2005 (DE) 10 2005 022 257.9

(51) Int. Cl. B32B 5/16; B05D 5/00

(52) U.S. Cl. 428/221; 427/7

(57) ABSTRACT

In order to protect a product against counterfeiting the invention proposes marking the product with a marking substance that can be detected clearly and unambiguously with suitable analysis methods.

The invention relates to a method of protecting a product against counterfeiting and a product manufactured in accordance with this method.

One conventional method of protecting a product against counterfeiting is to apply a mark to the product. Various methods of combining a trademark with the product in a non-removable manner are known. Such marks are printed, sewn-on or combined with the product as flags during the sewing procedure. Articles of clothing, in particular, are frequently copied. However, the production of cheap copies extends via the jewelry industry to machines and bulk goods, foodstuffs etc.

The counterfeits are frequently so well copied that it is becoming more and more difficult to distinguish the original from the counterfeit.

The aim of the invention is therefore to develop a method of protecting a product against counterfeiting that even during the manufacturing of large product quantities can be easily used and still allow the original to be distinguished from the counterfeit a long time after marking.

This aim is achieved by means of a method in which the product is marked with a marking substance that can easily and unambiguously be detected with suitable means of analysis.

The invention is based on the knowledge that it is possible to add marking substances to the product which, without causing damage to the product, remain combined with the product, if possible over the entire duration of the marketing process, and can therefore be easily detected in random checks.

Whereas previously it was necessary to trace back the marketing path to detect a counterfeit, it is now sufficient to mark all original products so that the non-marked products are clearly identified as counterfeits.

As the type of marking substance, its concentration and place of application generally remain a secret, the counterfeiter, who does not usually know about the special marking, will bring counterfeit products onto the market. Such counterfeits can initially be sold unhindered. However, if a counterfeit is suspected, a product is analysed to determine whether it is marked and whether the marking corresponds to the special type of original marking.

Although the costs of an analysis will generally exceed the costs of the marked products, the method in accordance with the invention is of great relevance to the market economy as random sample analyses are only carried out in the event of justified doubts as to authenticity. Normally the entire production batch is counterfeit if just one counterfeit product is found in a batch.

Particularly in the case of complaints and guarantee claims the manufacturer can thus determine whether the product is an original, so that guarantee claims do not have to be upheld for counterfeits.

In connection with the invention, the expression “clearly and unambiguously” means that when selecting the appropriate analysis method, an expert, for example, can after evaluating the results of the analysis state whether the sold product or other commercial material has been provided with a certain, clearly definable marking substance.

Preferably the product is doped in the sense of physical mixing as part of its manufacturing process. This shows that even the smallest quantities of a marking substance can be mixed into the product or parts of the product in order to distinguish original goods from counterfeits though such doping.

It has been shown that preferably products are manufactured which exhibit nano-particles with a diameter of less than 50 nanometers. Precisely such small nano-particles, although permitting simple detection, do not alter the product properties.

Tests have shown that it is advantageous if the product contains a rare earth, optionally oxides or salts, or mixed oxides or salts thereof, which in addition to other elements also contain rare earths. From the group of rare earths, lanthanoids in particular have proven to be suitable for the discussed purpose, on the one hand as they are economically available and on the other hand as they only occur in traces in the chemical or technical raw materials to be marked. Due to the phenomenon of lanthanoid contraction mixed crystals or crystal lattices doped with foreign ions can be produced in order to obtain a wide variation of marking substances.

Alternatively or in addition it is proposed that the product contains isotopes which do not, or only in traces, occur in nature, optionally also their oxides or salts, but also mixed oxides or complex salts, which in addition to other elements contain these isotopes. In particular it is proposed that the product does not contain radioactive isotopes. In principle actinoids or other rare earths are suitable as marking substances, whereby the isotopes of actinoids could be problematic because of their radioactivity.

A suitable analysis method is a method with which the described marking substances can be clearly and unambiguously detected. For example, said nano-particles can be clearly and unambiguously detected with the aid of mass spectrometry and/or atom absorption spectrometry (AAS), more particularly also by means of ICP-MS or other plasma methods. Specifically it is possible to clearly and unambiguously detect, for example, vanadates or phophates or isotopes occurring not at all, or only in traces, in nature, or rare earths with the aid of ICP-MS at a resolution of 1 in 1 million, e.g. one nanogram per gram of sold product or other commercial goods.

An essential advantage of the indicated marking substances is their general indifference to various application media. Introduced as a master batch or a dispersion or another form of application into the raw material of which the retail product of part thereof is manufactured, the marking substance is present in the material to be marked in traces of 1 to 10 ppm, without influencing the properties of the material. The substances also have very high levels of authenticity. Thus, their high temperature resistance meets the highest requirements and allows, for example, their use in PVC or polyolefins. They are generally UV stable and can therefore be used, for example, for coatings that are exposed to the weather. Their solvent-resistance predetermines them for use in textiles for example.

One form of embodiment of the method envisages that the material of which the product consists is marked in its entirety. For example an entire paper web can be marked. The same applies to paints, lacquers, coatings, plastics or bulk goods. The marking method is above all suitable for textile fibres or oils. In the case of all these materials the smallest dose of a marking substance is sufficient to alter the raw material in such a way the origin of the raw material can subsequently be determined on the finished product.

Alternatively or in addition it is envisaged that part of a product is marked in its entirety. For example, a particular component of a watch, a piece of jewelry or an electronic component can be marked in order to recognise a counterfeit of the entire product The methods are suitable for objects of a metallic nature and textiles. For example, the washing instruction and care label of textiles can be mentioned. By analysing a single care label of a textile the origin of an entire container consignment can be checked when the goods are delivered.

To produce a master batch, or a dispersion, or another suitable form of application reference is made to the generally known technology of dispersing solids, such as, for example, fillers and pigments. However, it should be ensured here that the marking substances are homogeneously distributed and stabilised against agglomeration.

The aim underlying the invention is achieved in that in accordance with one of the above methods a product is manufactured marked with a marking substance that can be clearly and unambiguously detected with suitable analysis methods.

In such a product the marking substance is present preferably in traces of 0.1 to 100, more particularly between 1 and 10 ppm in the material to be marked.

In order to cover a multiplicity of marking possibilities it is initially proposed that the marking substance contains several substances in combination which can be clearly and unambiguously detected with suitable analysis methods.

Alternatively or additionally it is proposed that the marking substance contains several of these substances is certain defined proportions.

One example of embodiment envisages that with the aid of a nonylphenoletoxilate in glycol a 0.2% homogeneous dispersion of ytterbium/erbium 1:1 mixed phosphate nanoparticles is produced by way of a dispersing or mixing device, e.g. a dissolver. This 0.2% dispersion of the marking substance is added to a coating, for example a timber protection varnish with 0.2% so that finally the varnish contains 4 ppm of the marking substance. That is to say 1 gram of the coating contains 1.3 μg each of ytterbium and erbium.

If 1 gram of this coating is rendered soluble with strong acids and prepared in accordance with the generally known detection procedures, the two indicated lantanoids can be clearly and unambiguously detected by way of mass spectroscopy and/or atom absorption spectroscopy (AAS), more particularly also by way of ICP-MS or other plasma methods. The detection threshold for ytterbium and erbium is around 0.1 μg/l in a graphite tube furnace.

1. Method of protecting a product against counterfeiting wherein the product is marked with a marking substance that can be clearly and unambiguously detected with suitable analysis methods.

2. Method in accordance with claim 1, wherein the product is doped in the sense of physical mixing as part of its manufacturing process.

3. Method in accordance with claim 1, wherein the product contains nano-particles with a diameter of less than 50 nanometers.

4. Method in accordance with claim 1, wherein the product contains a rare earth, optionally its oxides or salts, or mixed oxides or complex salts, which in addition to other elements also contains rare earths.

5. Method in accordance with claim 1, wherein the product contains a lanthanoid.

6. Method in accordance with claim 1, wherein the product contains mixed crystals or also crystal lattices doped with foreign ions.

7. Method in accordance with claim 1, wherein the product contains isotopes which do not, or only in traces, occur in nature, optionally their oxides or salts, but also mixed oxides or complex salts, which in addition to other elements contain these isotopes.

8. Method in accordance with claim 1, wherein the product does not contain radioactive isotopes.

9. Method in accordance with claim 1, wherein the material of which the product consists is marked in its entirety.

10. Method in accordance with claim 1, wherein part of a product is marked in its entirety.

11. Method in accordance with claim 1, wherein the marking substances are homogeneously distributed and stabilised against agglomeration.

12. Product, more particularly manufactured in accordance with claim 1, wherein the product is marked with a marking substance that can be clearly and unambiguously detected with suitable analysis methods.

13. Product in accordance with claim 12, wherein the marking substance is present in traces of 0.1 to 100, preferably 1 to 10 ppm in the material to be marked.

14. Product in accordance with claim 12, wherein the marking substance contains several substances in combination which can be clearly and unambiguously detected with suitable analysis methods.

15. Product in accordance with claim 14, wherein the marking substance contains a mixture of these substances in certain defined proportions.
